(19) United States
(12) Patent Application Publication
(10) Pub. No.: US 2025/0375267 A1
(43) Pub. Date: Dec. 11, 2025

(54) Dental Aligner Removal Tool

(71) Applicant: Nadine Saubers, La Mesa, CA (US)

(72) Inventor: Nadine Saubers, La Mesa, CA (US)

(21) Appl. No.: 19/208,377

(22) Filed: May 14, 2025

Related U.S. Application Data
(63) Continuation-in-part of application No. 30/002,229, filed on May 2, 2025.
(60) Provisional application No. 63/656,426, filed on Jun. 5, 2024.

(51) Int. Cl. A61C 7/02; A61C 7/08

(52) U.S. Cl. CPC A61C 7/023; A61C 7/08

(57) ABSTRACT

A dental aligner removal tool is a device that facilitates the detachment of removable tooth positioning appliances, specifically clear aligners and other dental appliances, efficiently, safely, and hygienically from the teeth of a patient. The device includes a hook appendage, a lever appendage, an appendage hub, a tool arm, and a tool handle. The hook appendage is used to engage and loosen a top teeth aligner, while the lever appendage is used to engage and loosen a bottom teeth aligner. The appendage hub connects the hook appendage and the lever appendage to the tool arm to form a single structure. Similarly, the tool arm connects the appendage hub to the tool handle. Further, the tool handle enables the user to hold the device securely with two fingers and a thumb while exerting the force necessary to loosen and remove the target teeth aligner.

### FIELD OF THE INVENTION

The present invention generally relates to dental instruments and accessories. More specifically, the present invention discloses novel means for detaching removable tooth positioning appliances, specifically clear aligners and other dental appliances, efficiently, safely, and hygienically from the teeth of a patient.

### BACKGROUND OF THE INVENTION

Clear Aligner Therapy (CAT) or removable tooth positioning appliances (aligners) correspond to a type of orthodontic device that fits closely on the teeth. An aligner is a plastic shell that snaps over the teeth, is nearly invisible, and applies gentle pressure on the teeth to gradually straighten teeth over a prescribed period. CAT is growing in popularity and is often used in lieu of metal wire braces in orthodontic treatment to move the teeth to a predetermined position. Clear plastic aligners are not bonded to teeth but are made to be removed for eating, drinking, brushing, and flossing, and during dental procedures. Moreover, aligners are manufactured by making a mold of the patient's teeth, which is then used to create a digital image of the teeth. A computerized model suggests stages between the current and desired tooth position, and individual aligners are customized for each stage. Aligners are worn for 22 to 23 hours a day for one or two weeks after which the patient begins a new set of aligners. An average CAT lasts nine to fifteen months, and the average number of aligners worn during treatment is between 18 and 30, although both vary from case to case. After the teeth have been moved into the final position, patients are then only required to wear the aligners at night.

To achieve the repositioning forces required to move a tooth from the original position to the target position, aligners must be relatively stiff and tight to provide a sufficient grip on the teeth. The stiffness and tightness provide the repositioning force necessary to move the teeth and ensures that the appliance remains firmly in position on the patient's teeth. The stiffness and tightness also permit the aligner to grab hold of an anchor device or attachment on the tooth to apply a direct force to execute orthodontic tooth movements. However, the stiffness of the aligner and the requirement that the aligner tightly conform to the teeth often makes the removal of these aligners difficult and sometimes painful. The removal of aligners many times during the patient's daily life is necessary for cleaning, dental hygiene, eating, and replacement during treatment. Patients may attempt to use fingers and fingernails to remove the aligners, which many find unsanitary when continuously inserting fingers into the mouth. Because removal of the aligner requires a lever action, patients also attempt to use household instruments such as forks or spoons. However, using improvised instruments can damage the patient's teeth, gums, or tear the aligners. Therefore, there is a need for a tool to help the user easily, safely, and hygienically remove aligners without damaging the appliance, teeth, gums, or fingernails.

The objective of the present invention is to provide a lightweight and convenient tool that is specifically designed to remove such tooth positioning appliances from a patient's teeth in a safe, easy, and effective manner is desirable. The present invention facilitates the removal of tooth positioning appliances including, but not limited to, top and bottom teeth aligners. Other aligner removal tools currently available only include a hook on the distal end and a pull ring on the proximal end. On the other hand, the present invention provides hook and lever appendages that allow the removal of both top and bottom teeth aligners, respectively. Further, the hook and lever appendages are fused into one to form a strong structure that is unable to break or bend.

Moreover, the present invention is designed as a light, compact, easy, and safe to use tool. The present invention includes an integrated handle that offers superior grip force for safe removal of the teeth aligners. The present invention also has a portable and practical design able to fit into typical aligner cases. Further, the present invention can be safely used without any special training. Additional features and benefits of the present invention are further discussed in the sections below.

### SUMMARY OF THE INVENTION

The present invention discloses a dental aligner removal tool designed to facilitate the safe removal of clear aligners without assistance from another person or tool. To do so, the present invention includes a hook appendage and a lever appendage that facilitate the removal of the top and bottom teeth aligners, respectively. Both hook and lever appendages are designed to loosen clear aligners from the teeth without damaging the appliance nor the teeth. The present invention is designed to be comfortably operated using a single hand to remove clear aligners without assistance from another person. Further, the present invention has a portable design that can be carried along with the aligners so that the user can have access to both anytime. Furthermore, the present invention can be made from materials that are safe for the user, such as Polypropylene (PP #5) food-grade plastic. However, different materials can be utilized that allow the present invention to be safely used by any person.

### BRIEF DESCRIPTION OF THE DRAWINGS

FIG. 1 is a top-front-right perspective view of the present invention.

FIG. 2 is a bottom-rear-left perspective view of the present invention.

FIG. 3 is a left view of the present invention.

FIG. 4 is a right view of the present invention, wherein the present invention is shown held with a hand.

FIG. 5 is a bottom-left perspective view of the present invention, wherein the present invention is shown removing the top teeth aligner.

FIG. 6 is a left view of the present invention, wherein the present invention is shown removing the bottom teeth aligner.

### DETAIL DESCRIPTIONS OF THE INVENTION

All illustrations of the drawings are for the purpose of describing selected versions of the present invention and are not intended to limit the scope of the present invention.

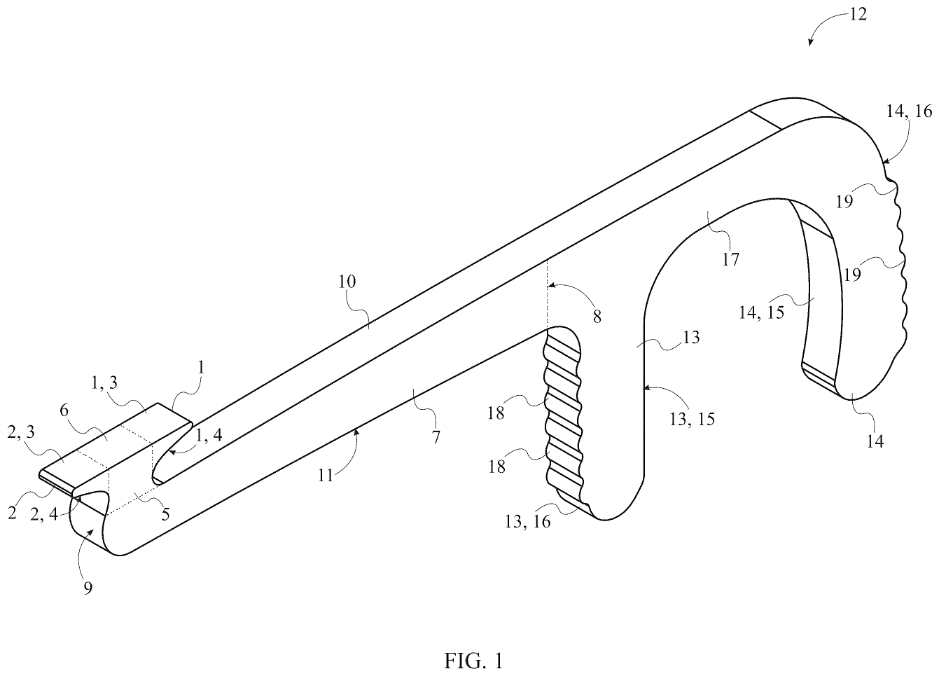

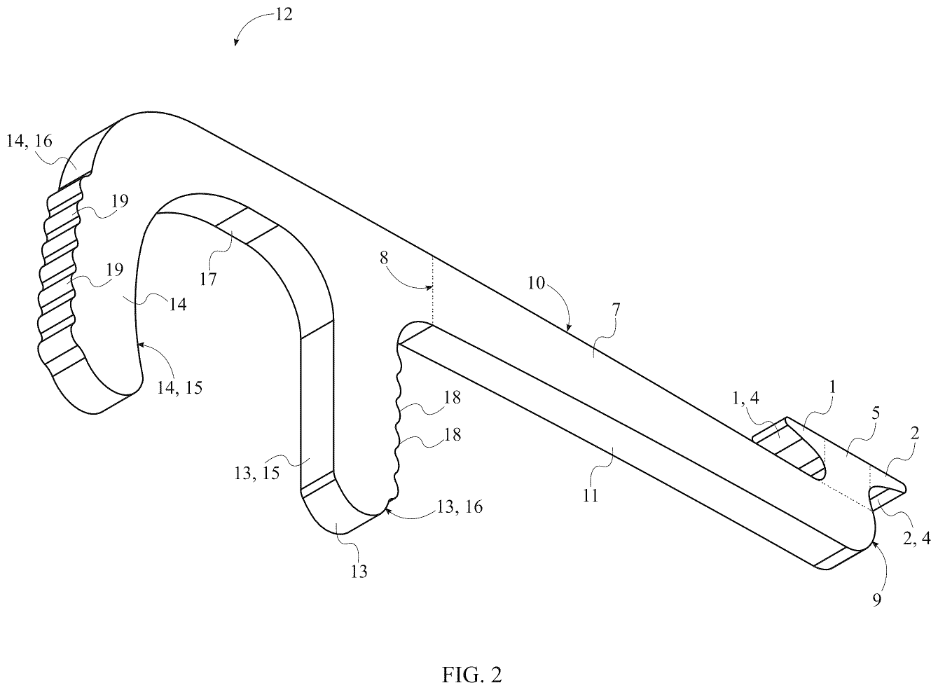

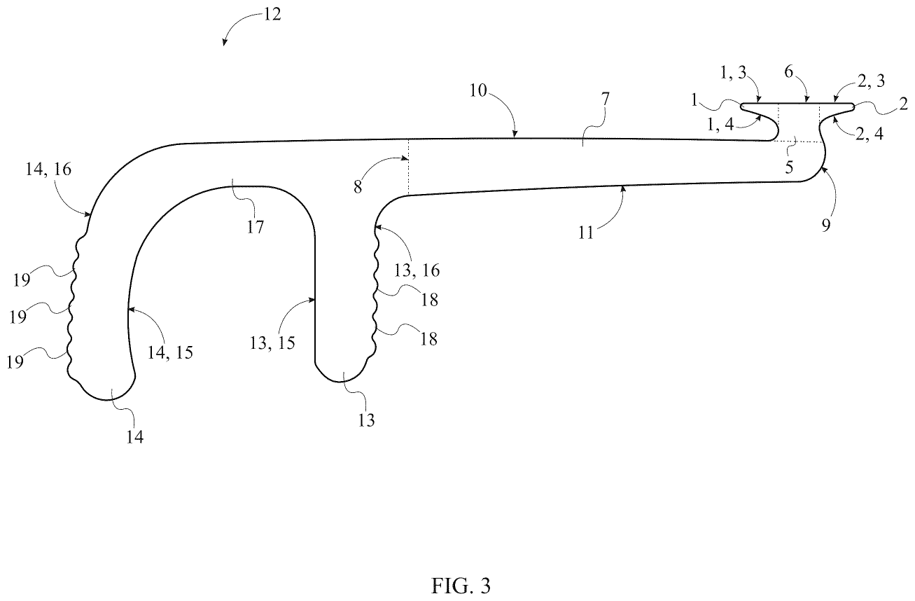

The present invention discloses a dental aligner removal tool that facilitates the detachment of removable tooth positioning appliances, specifically clear aligners and other dental appliances, efficiently, safely, and hygienically from the teeth of a patient. As can be seen in FIGS. 1 through 6, the present invention comprises a hook appendage 1, a lever appendage 2, an appendage hub 5, a tool arm 7, and a tool handle 12. The hook appendage 1 is used to engage and loosen a top teeth aligner, while the lever appendage 2 is used to engage and loosen a bottom teeth aligner. The appendage hub 5 connects the hook appendage 1 and the lever appendage 2 to the tool arm 7 to form a single structure. Similarly, the tool arm 7 connects the appendage hub 5 to the tool handle 12. Further, the tool handle 12 enables the user to hold the present invention securely with at least one finger and a thumb while exerting the force necessary to loosen and remove the target teeth aligner.

The general configuration of the aforementioned components enables the safe and efficient detachment of teeth aligners without damaging the teeth aligners or the user. As can be seen in FIGS. 1 through 6, the tool arm 7 is preferably a flat elongated structure long enough to offset the appendage hub 5 from the tool handle 12. The tool arm 7 is long enough so that the user's fingers do not need to be inserted into the mouth to reach the target teeth aligner. In general, the tool arm 7 comprises a proximal arm end 8, a distal arm end 9, a first lateral face 10, and a second lateral face 11. The proximal arm end 8 and the distal arm end 9 correspond to the terminal ends of the tool arm 7 formed by the elongated design of the tool arm 7. The first lateral face 10 and the second lateral face 11 correspond to two opposite surfaces of the tool arm 7 formed by the flat design of the tool arm 7. The first lateral face 10 and the second lateral face 11 are preferably the thinner surfaces of the tool arm 7. However, the first lateral face 10 and the second lateral face 11 can correspond to different surfaces of the tool arm 7.

In the preferred embodiment, the present invention can be arranged as follows: the first lateral face 10 and the second lateral face 11 are positioned opposite each other across the tool arm 7 due to the flat design of the tool arm 7, as can be seen in FIGS. 1 through 6. The tool handle 12 is terminally connected to the proximal arm end 8 to secure the tool arm 7 to the tool handle 12. Similarly, the appendage hub 5 is laterally connected to the first lateral face 10, adjacent to the distal arm end 9, to secure the appendage hub 5 to the tool arm 7. Further, the hook appendage 1 and the lever appendage 2 are positioned offset to the first lateral face 10 to separate the hook appendage 1 and the lever appendage 2 from the tool arm 7. In addition, the hook appendage 1 and the lever appendage 2 are positioned opposite each other across the appendage hub 5 to separate the hook appendage 1 from the lever appendage 2. The present invention is preferably designed as a flat tool. So, the hook appendage 1 is oriented towards the tool arm 7, while the lever appendage 2 is oriented away from the tool arm 7. This allows the hook appendage 1 and the lever appendage 2 along with the appendage hub 5 to form an overall flat structure. Further, the hook appendage 1 and the lever appendage 2 are both laterally connected to the appendage hub 5 to the opposite sides of the appendage hub 5. In other embodiments, different arrangements can be implemented to accommodate different tool designs.

As previously discussed, the present invention is designed as a durable and safe-to-use product that the user can repeatedly use during the treatment period of the teeth realignment. In the preferred embodiment, the hook appendage 1, the lever appendage 2, the appendage hub 5, the tool arm 7, and the tool handle 12 are made from a single piece of rigid material. In other words, the present invention is preferably manufactured as a single rigid product that is hard to deform to ensure durability. In addition, the material used to manufacture the present invention is preferably a material that is safe for people to use since portions of the tool are inserted into the mouth. So, the single piece of rigid material is preferably a food-grade plastic. In other embodiments, different structural designs can be implemented, such as modular designs, and different materials can be utilized that are not plastics but still safe for people.

Due to the tight engagement between the teeth and the teeth aligner, both the hook appendage 1 and the lever appendage 2 need to safely be positioned between the teeth aligner and the teeth to loosen the teeth aligner, as can be seen in FIGS. 1 through 6. In the preferred embodiment, the appendage hub 5, the lever appendage 2, and the hook appendage 1 form a flat pickaxe-like structure with the tool arm 7 that can be easily maneuvered to disengage the target teeth aligner. So, the appendage hub 5 comprises a free hub surface 6 corresponding to the flat surface opposite the first lateral face 10 that is not connected to the tool arm 7.

Further, the hook appendage 1 and the lever appendage 2 each comprises a tooth-engaging surface 3 and an aligner-engaging surface 4. As can be seen in FIGS. 1 through 6, the tooth-engaging surface 3 and the aligner-engaging surface 4 correspond to the two largest opposite surfaces of each appendage. As the name suggests, the tooth-engaging surface 3 corresponds to the surface that braces the tooth when the appendage is positioned between the teeth and the teeth aligner. On the other hand, the aligner-engaging surface 4 corresponds to the surface that braces the teeth aligner when the appendage is positioned between the teeth and the teeth aligner. In general, the free hub surface 6 is positioned opposite the first lateral face 10 across the appendage hub 5 since the appendage hub 5 is planarly aligned with the tool arm 7. Further, the tooth-engaging surface 3 of the hook appendage 1 and the tooth-engaging surface 3 of the lever appendage 2 are coplanar with the free hub surface 6 to form a single flat surface. This allows the chosen appendage to be safely slid into the gap between the teeth and the teeth aligner. Further, the aligner-engaging surface 4 of the hook appendage 1 and the aligner-engaging surface 4 of the lever appendage 2 are oriented towards the first lateral face 10 to complete the flat pickaxe-like structure.

As can be seen in FIGS. 1 through 6, to further facilitate the disengagement of a top teeth aligner, the aligner-engaging surface 4 of the hook appendage 1 tapers away from the appendage hub 5. This allows the hook appendage 1 to be inserted into the gap between the tooth and the top teeth aligner. As the hook appendage 1 is inserted, the wedge shape of the hook appendage 1 loosens the top teeth aligner from the teeth. Once disengaged, the user can pull the top teeth aligner down to remove the top teeth aligner. Similarly, to further facilitate the disengagement of a bottom teeth aligner, the aligner-engaging surface 4 of the lever appendage 2 also tapers away from the appendage hub 5. This allows the lever appendage 2 to be inserted into the gap between the tooth and the bottom teeth aligner. As the lever appendage 2 is inserted, the wedge shape of the lever appendage 2 loosens the bottom aligner from the teeth. Once disengaged, the user can push the bottom teeth aligner up to remove the bottom teeth aligner. In other embodiments, the hook appendage 1 and/or the lever appendage 2 may include different structural designs.

As previously discussed, the tool handle 12 enables the user to efficiently maneuver the present invention. In the preferred embodiment, the tool handle 12 is designed to be gripped using at least one finger and the thumb comfortably, as can be seen in FIGS. 1 through 6. To do so, the tool handle 12 may comprise a first handle leg 13, a second handle leg 14, and a handle bridge 17. The first handle leg 13 and the second handle leg 14 correspond to two elongated protrusions that are long enough to be gripped by fingers. The handle bridge 17 corresponds to a short protrusion that connects the first handle leg 13 and the second handle leg 14 together. Further, the first handle leg 13, the second handle leg 14, and the handle bridge 17 are preferably arranged into a U-shaped structure that conforms to the curvature of a finger.

This embodiment of the tool handle 12 can be implemented as follows: the handle bridge 17 is axially aligned with the tool arm 7 so that a continuous elongated flat structure is formed, as can be seen in FIGS. 1 through 6. In addition, the handle bridge 17 is terminally connected to the proximal arm end 8 to secure the handle bridge 17 to the tool arm 7. Further, the first handle leg 13 and the second handle leg 14 each are oriented away from the second lateral face 11 to maintain an overall flat structure. In other words, the first handle leg 13 and the second handle leg 14 are oriented in the opposite direction to the appendage hub 5. Each handle leg can be oriented at different angles with the tool arm 7 to form an ergonomic structure that is comfortable to grip using two or three fingers. For example, the first handle leg 13 can be oriented perpendicular to tool arm 7, while the second handle leg 14 can have a curved concave design that matches the curvature of a finger.

Further, the first handle leg 13 and the second handle leg 14 are positioned opposite each other along the handle bridge 17. As can be seen in FIGS. 1 through 6, the distance between the first handle leg 13 and the second handle leg 14 forms a space large enough to accommodate a finger between the first handle leg 13 and the second handle leg 14. In addition, the first handle leg 13 is terminally connected to the handle bridge 17, adjacent to the proximal arm end 8, to secure the first handle leg 13 to the handle bridge 17. Similarly, the second handle leg 14 is terminally connected to the handle bridge 17, offset to the first handle leg 13, to secure the second handle leg 14 to the handle bridge 17. As previously discussed, the present invention is preferably provided as a single rigid structure, so the handle bridge 17, the first handle leg 13, and the second handle leg 14 are part of the same structure as the tool arm 7. In alternate embodiments, the handle bridge 17, the first handle leg 13, and the second handle leg 14 are provided as separate components assembled together with the tool arm 7.

As can be seen in FIGS. 1 through 6, the tool handle 12 is designed to be securely gripped using at least one finger and the thumb. However, due to the potential presence of fluids while removing the teeth aligners, additional grip features may be necessary. In some embodiments, the tool handle 12 may further comprise a plurality of first grip protrusions 18 that increases the grip of a finger grabbing the first handle leg 13. The plurality of first grip protrusions 18 preferably include several round protrusions arranged in series that increase the grip of the finger on the first handle leg 13. In addition, the first handle leg 13 may comprise an inner leg surface 15 and an outer leg surface 16 corresponding to two opposite surfaces of the first handle leg 13.

In the preferred embodiment, the plurality of first grip protrusions 18 is implemented as follows: the inner leg surface 15 of the first handle leg 13 is oriented towards the second handle leg 14 while the outer leg surface 16 of the first handle leg 13 is oriented away from the second handle leg 14, as can be seen in FIGS. 1 through 6. The arrangement of the inner leg surface 15 and the outer leg surface 16 of the first handle leg 13 is due to the flat design of the present invention. Further, the plurality of first grip protrusions 18 is distributed along the outer leg surface 16 of the first handle leg 13. The number and distribution of the plurality of first grip protrusions 18 depends on the size of the first handle leg 13 as well as the shape and/or size of each of the plurality of first grip protrusions 18. Furthermore, the plurality of first grip protrusions 18 is mounted onto the outer leg surface 16 of the first handle leg 13 to implement the plurality of first grip protrusions 18 on the first handle leg 13.

Similar to the first handle leg 13, the second handle leg 14 may also include gripping features to increase the grip of a finger on the second handle leg 14. In some embodiments, the tool handle 12 may further comprise a plurality of second grip protrusions 19 that increases the grip of a finger grabbing the second handle leg 14, as can be seen in FIGS. 1 through 6. The plurality of second grip protrusions 19 preferably include several round protrusions arranged in series that increase the grip of the finger on the second handle leg 14. In addition, the second handle leg 14 may also comprise an inner leg surface 15 and an outer leg surface 16 corresponding to two opposite surfaces of the second handle leg 14.

In the preferred embodiment, the plurality of second grip protrusions 19 is implemented as follows: the inner leg surface 15 of the second handle leg 14 is oriented towards the first handle leg 13 while the outer leg surface 16 of the second handle leg 14 is oriented away from the first handle leg 13, as can be seen in FIGS. 1 through 6. The arrangement of the inner leg surface 15 and the outer leg surface 16 of the second handle leg 14 is also due to the flat design of the present invention. Further, the plurality of second grip protrusions 19 is distributed along the outer leg surface 16 of the second handle leg 14. The number and distribution of the plurality of second grip protrusions 19 also depends on the size of the second handle leg 14 as well as the shape and/or size of each of the plurality of second grip protrusions 19. Furthermore, the plurality of second grip protrusions 19 is mounted onto the outer leg surface 16 of the second handle leg 14 to implement the plurality of second grip protrusions 19 on the first handle leg 13. In other embodiments, different gripping features or mechanisms can be implemented on the inner leg surface 15 and/or outer leg surface 16 of the first handle leg 13 and/or the second handle leg 14.

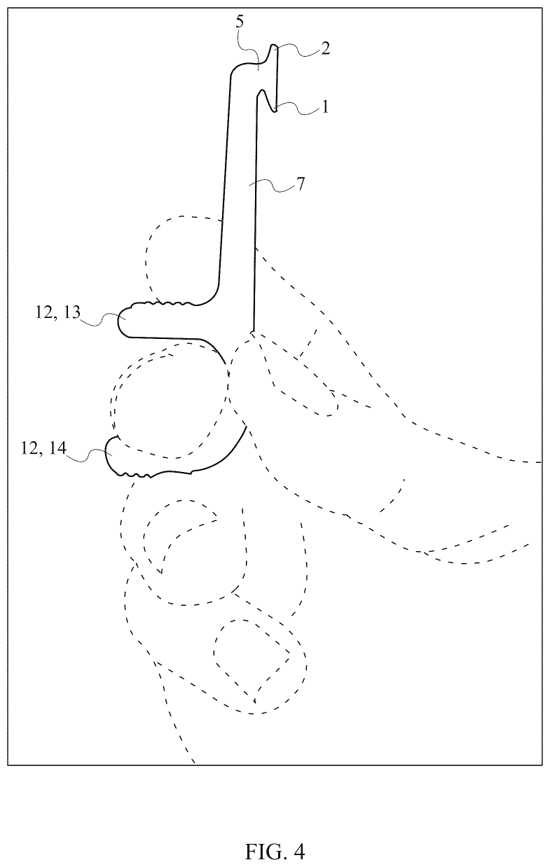

As previously discussed, the present invention can be easily and safely used by the user without previous training or additional tools. In an exemplary embodiment, the overall process of a method of the present invention can be performed by the user as follows: the tool handle 12 is first gripped one or two fingers and the thumb, as can be seen in FIG. 4. For example, the index finger can be positioned against the outer leg surface 16 of the first handle leg 13, the middle finger can be positioned against the inner leg surface 15 of the second handle leg 14, and the thumb can be positioned against the outer leg surface 16 of the second handle leg 14. Once the device is properly held, the user can hold the present invention upright with the appendage hub 5 oriented towards the mouth.

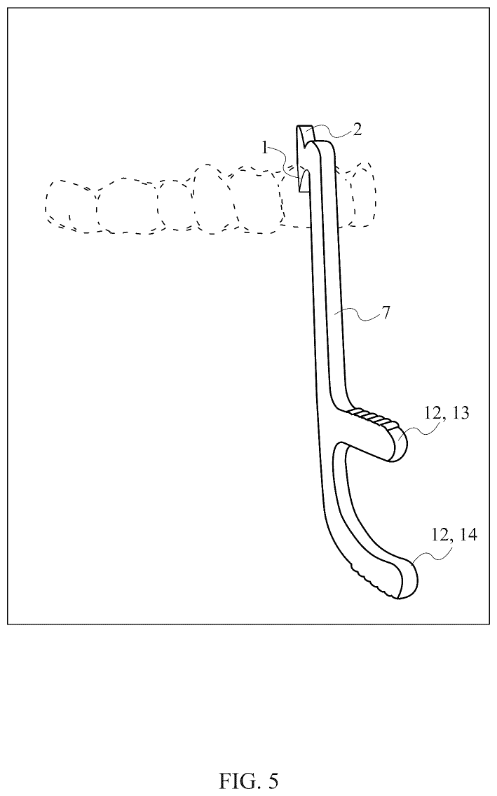

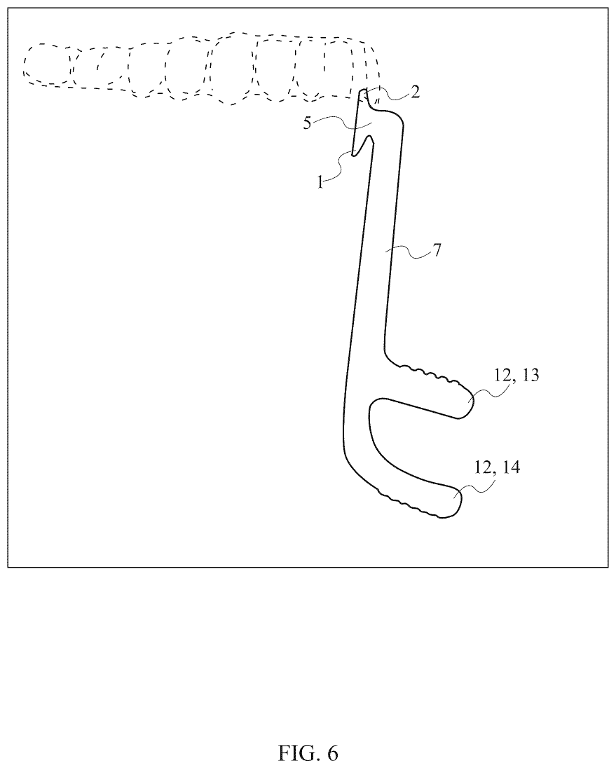

Depending on the teeth aligner the user wants to remove, the hook appendage 1 or the lever appendage 2 is maneuvered accordingly. As can be seen in FIG. 5, if the top teeth aligner is to be removed, the user moves the hook appendage 1 towards the top tooth aligner so that the hook appendage 1 can be engaged. The hook appendage 1 is moved into the gap between a tooth and the top teeth aligner until the top teeth aligner is loosened and can then be disengaged. As can be seen in FIG. 6, if the bottom teeth aligner is to be removed, the user moves the lever appendage 2 towards the bottom tooth aligner so that the lever appendage 2 can be engaged. The lever appendage 2 is moved into the gap between a tooth and the bottom teeth aligner until the bottom teeth aligner is loosened and can then be disengaged.

Excessive force is not recommended when removing the teeth aligners. If the user is having difficulty in one area, the user should move to a different tooth and try again.

Different areas may be necessary to be engaged to fully loosen the teeth aligners depending on how tightly engaged the teeth aligners are. Further, the present invention should not be pulled/pushed forcefully to prevent damage to the teeth aligners and/or the teeth. For very tight aligners, the user should rinse the mouth with warm water prior to removal to loosen the teeth aligners. In other embodiments, the method of operation of the present invention may be modified to accommodate other dental appliances or features of the present invention.

Although the invention has been explained in relation to its preferred embodiment. it is to be understood that many other possible modifications and variations can be made without departing from the spirit and scope of the invention.

What is claimed is:

1. A dental aligner removal tool comprising:
a hook appendage;
a lever appendage;
an appendage hub;
a tool arm;
a tool handle;
the tool arm comprising a proximal arm end, a distal arm end, a first lateral face, and a second lateral face;
the first lateral face and the second lateral face being positioned opposite each other across the tool arm;
the tool handle being terminally connected to the proximal arm end;
the appendage hub being laterally connected to the first lateral face, adjacent to the distal arm end;
the hook appendage and the lever appendage being positioned offset to the first lateral face;
the hook appendage and the lever appendage being positioned opposite each other across the appendage hub;
the hook appendage being oriented towards the tool arm;
the hook appendage being laterally connected to the appendage hub;
the lever appendage being oriented away from the tool arm; and
the lever appendage being laterally connected to the appendage hub.

2. The dental aligner removal tool as claimed in claim 1, wherein the hook appendage, the lever appendage, the appendage hub, the tool arm, and the tool handle are made from a single piece of rigid material.

3. The dental aligner removal tool as claimed in claim 2, wherein the single piece of rigid material is a food-grade plastic.

4. The dental aligner removal tool as claimed in claim 1 further comprising:
the appendage hub comprising a free hub surface;
the hook appendage and the lever appendage each comprising a tooth-engaging surface and an aligner-engaging surface;
the free hub surface being positioned opposite the first lateral face across the appendage hub;
the tooth-engaging surface of the hook appendage and the tooth-engaging surface of the lever appendage being coplanar with the free hub surface; and
the aligner-engaging surface of the hook appendage and the aligner-engaging surface of the lever appendage being oriented towards the first lateral face.

5. The dental aligner removal tool as claimed in claim 4, wherein the aligner-engaging surface of the hook appendage tapers away from the appendage hub.

6. The dental aligner removal tool as claimed in claim 4, wherein the aligner-engaging surface of the lever appendage tapers away from the appendage hub.

7. The dental aligner removal tool as claimed in claim 1 further comprising:
the tool handle comprising a first handle leg, a second handle leg, and a handle bridge;
the handle bridge being axially aligned with the tool arm;
the handle bridge being terminally connected to the proximal arm end;
the first handle leg and the second handle leg each being oriented away from the second lateral face;
the first handle leg and the second handle leg being positioned opposite each other along the handle bridge;
the first handle leg being terminally connected to the handle bridge, adjacent to the proximal arm end; and
the second handle leg being terminally connected to the handle bridge, offset to the first handle leg.

8. The dental aligner removal tool as claimed in claim 7 further comprising:
the tool handle further comprising a plurality of first grip protrusions;
the first handle leg comprising an inner leg surface and an outer leg surface;
the inner leg surface of the first handle leg being oriented towards the second handle leg;
the outer leg surface of the first handle leg being oriented away from the second handle leg;
the plurality of first grip protrusions being distributed along the outer leg surface of the first handle leg; and
the plurality of first grip protrusions being mounted onto the outer leg surface of the first handle leg.

9. The dental aligner removal tool as claimed in claim 7 further comprising:
the tool handle further comprising a plurality of second grip protrusions;
the second handle leg comprising an inner leg surface and an outer leg surface;
the inner leg surface of the second handle leg being oriented towards the first handle leg;
the outer leg surface of the second handle leg being oriented away from the first handle leg;
the plurality of second grip protrusions being distributed along the outer leg surface of the second handle leg; and
the plurality of second grip protrusions being mounted onto the outer leg surface of the second handle leg.

10. A dental aligner removal tool comprising:
a hook appendage;
a lever appendage;
an appendage hub;
a tool arm;
a tool handle;
the tool arm comprising a proximal arm end, a distal arm end, a first lateral face, and a second lateral face;
the first lateral face and the second lateral face being positioned opposite each other across the tool arm;
the tool handle being terminally connected to the proximal arm end;
the appendage hub being laterally connected to the first lateral face, adjacent to the distal arm end;
the hook appendage and the lever appendage being positioned offset to the first lateral face;
the hook appendage and the lever appendage being positioned opposite each other across the appendage hub;
the hook appendage being oriented towards the tool arm;
the hook appendage being laterally connected to the appendage hub;
the lever appendage being oriented away from the tool arm;
the lever appendage being laterally connected to the appendage hub; and
the hook appendage, the lever appendage, the appendage hub, the tool arm, and the tool handle being made from a single piece of rigid material.

11. The dental aligner removal tool as claimed in claim 10, wherein the single piece of rigid material is a food-grade plastic.

12. The dental aligner removal tool as claimed in claim 10 further comprising:
the appendage hub comprising a free hub surface;
the hook appendage and the lever appendage each comprising a tooth-engaging surface and an aligner-engaging surface;
the free hub surface being positioned opposite the first lateral face across the appendage hub;
the tooth-engaging surface of the hook appendage and the tooth-engaging surface of the lever appendage being coplanar with the free hub surface;
the aligner-engaging surface of the hook appendage and the aligner-engaging surface of the lever appendage being oriented towards the first lateral face;
the aligner-engaging surface of the hook appendage tapering away from the appendage hub; and
the aligner-engaging surface of the lever appendage tapering away from the appendage hub.

13. The dental aligner removal tool as claimed in claim 10 further comprising:
the tool handle comprising a first handle leg, a second handle leg, and a handle bridge;
the handle bridge being axially aligned with the tool arm;
the handle bridge being terminally connected to the proximal arm end;
the first handle leg and the second handle leg each being oriented away from the second lateral face;
the first handle leg and the second handle leg being positioned opposite each other along the handle bridge;
the first handle leg being terminally connected to the handle bridge, adjacent to the proximal arm end; and
the second handle leg being terminally connected to the handle bridge, offset to the first handle leg.

14. The dental aligner removal tool as claimed in claim 13 further comprising:
the tool handle further comprising a plurality of first grip protrusions;
the first handle leg comprising an inner leg surface and an outer leg surface;
the inner leg surface of the first handle leg being oriented towards the second handle leg;
the outer leg surface of the first handle leg being oriented away from the second handle leg;
the plurality of first grip protrusions being distributed along the outer leg surface of the first handle leg; and
the plurality of first grip protrusions being mounted onto the outer leg surface of the first handle leg.

15. The dental aligner removal tool as claimed in claim 13 further comprising:
the tool handle further comprising a plurality of second grip protrusions;
the second handle leg comprising an inner leg surface and an outer leg surface;
the inner leg surface of the second handle leg being oriented towards the first handle leg;
the outer leg surface of the second handle leg being oriented away from the first handle leg;
the plurality of second grip protrusions being distributed along the outer leg surface of the second handle leg; and
the plurality of second grip protrusions being mounted onto the outer leg surface of the second handle leg.

16. A dental aligner removal tool comprising:
a hook appendage;
a lever appendage;
an appendage hub;
a tool arm;
a tool handle;
the tool arm comprising a proximal arm end, a distal arm end, a first lateral face, and a second lateral face;
the first lateral face and the second lateral face being positioned opposite each other across the tool arm;
the tool handle being terminally connected to the proximal arm end;
the appendage hub being laterally connected to the first lateral face, adjacent to the distal arm end;
the hook appendage and the lever appendage being positioned offset to the first lateral face;
the hook appendage and the lever appendage being positioned opposite each other across the appendage hub;
the hook appendage being oriented towards the tool arm;
the hook appendage being laterally connected to the appendage hub;
the lever appendage being oriented away from the tool arm;
the lever appendage being laterally connected to the appendage hub; and
the hook appendage, the lever appendage, the appendage hub, the tool arm, and the tool handle being made from a single piece of rigid food-grade plastic.

17. The dental aligner removal tool as claimed in claim 16 further comprising:
the appendage hub comprising a free hub surface;
the hook appendage and the lever appendage each comprising a tooth-engaging surface and an aligner-engaging surface;
the free hub surface being positioned opposite the first lateral face across the appendage hub;
the tooth-engaging surface of the hook appendage and the tooth-engaging surface of the lever appendage being coplanar with the free hub surface;
the aligner-engaging surface of the hook appendage and the aligner-engaging surface of the lever appendage being oriented towards the first lateral face;
the aligner-engaging surface of the hook appendage tapering away from the appendage hub; and
the aligner-engaging surface of the lever appendage tapering away from the appendage hub.

18. The dental aligner removal tool as claimed in claim 16 further comprising:
the tool handle comprising a first handle leg, a second handle leg, and a handle bridge;
the handle bridge being axially aligned with the tool arm;
the handle bridge being terminally connected to the proximal arm end;
the first handle leg and the second handle leg each being oriented away from the second lateral face;
the first handle leg and the second handle leg being positioned opposite each other along the handle bridge;
the first handle leg being terminally connected to the handle bridge, adjacent to the proximal arm end; and
the second handle leg being terminally connected to the handle bridge, offset to the first handle leg.

19. The dental aligner removal tool as claimed in claim 18 further comprising:
the tool handle further comprising a plurality of first grip protrusions;
the first handle leg comprising an inner leg surface and an outer leg surface;
the inner leg surface of the first handle leg being oriented towards the second handle leg;
the outer leg surface of the first handle leg being oriented away from the second handle leg;
the plurality of first grip protrusions being distributed along the outer leg surface of the first handle leg; and
the plurality of first grip protrusions being mounted onto the outer leg surface of the first handle leg.

20. The dental aligner removal tool as claimed in claim 18 further comprising:
the tool handle further comprising a plurality of second grip protrusions;
the second handle leg comprising an inner leg surface and an outer leg surface;
the inner leg surface of the second handle leg being oriented towards the first handle leg;
the outer leg surface of the second handle leg being oriented away from the first handle leg;
the plurality of second grip protrusions being distributed along the outer leg surface of the second handle leg; and
the plurality of second grip protrusions being mounted onto the outer leg surface of the second handle leg.
